(19) United States
(12) Patent Application Publication
(10) Pub. No.: US 2007/0097891 A1
(43) Pub. Date: May 3, 2007

(54) Unlicensed band heterogeneous network coexistence algorithm

(76) Inventor: Duncan M. Kitchin, Beaverton, OR (US)

Correspondence Address: INTEL CORPORATION;C/O INTELLEVATE, LLC, P.O. BOX 52050, MINNEAPOLIS, MN, 55402, US

(21) Appl. No.: 11/260,894

(22) Filed: Oct. 27, 2005

(51) Int. Cl. H04B 7/00

(52) U.S. Cl. 370/310

(57) ABSTRACT

A transceiver to transmit over a channel a sequence of transmissions that is recognizable by other devices that employ a similar wireless protocol. Other devices that have a different wireless protocol are unable to decode transmissions from the transceiver and interpret the sequence of transmissions as being a primary user of a frequency band and these other devices cease transmissions on the channel.

Recent developments in a number of different digital technologies have greatly increased the need to transfer large amounts of data from one network or system to another. Technological developments permit digitization and compression of large amounts of voice, video, imaging, and data information, which may be rapidly transmitted from computers and other digital equipment to other devices within a network. Computers have faster central processing units and substantially increased memory capabilities, which have increased the demand for devices that can more quickly transfer larger amounts of data. These developments in digital technology have stimulated a need for spectrum to be used for wireless interconnection within and among these networks. Unlicensed access to this spectrum permits inexpensive broadband wireless computer networks, and thereby provides cost-effective access to an array of multimedia services. However, shared spectrum opens the possibility of interference, and better methods are needed for handling interference resulting from devices vying to use this unlicensed spectrum.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that incorporates circuitry and an algorithm to enable wireless devices having different protocols to coexist in heterogeneous unlicensed networks in accordance with the present invention;

FIG. 2 is a diagram that illustrates unlicensed users and their transmission footprints;

FIG. 3 is a diagram that illustrates a series of packets generated by the wireless device of FIG. 1 to announce to other devices that a channel has been reserved; and

FIG. 4 shows a flowchart that describes a method allowing wireless devices having different protocols to operate in the same frequency bands.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements may or may not be in direct contact with each other, but yet still co-operate or interact with each other.

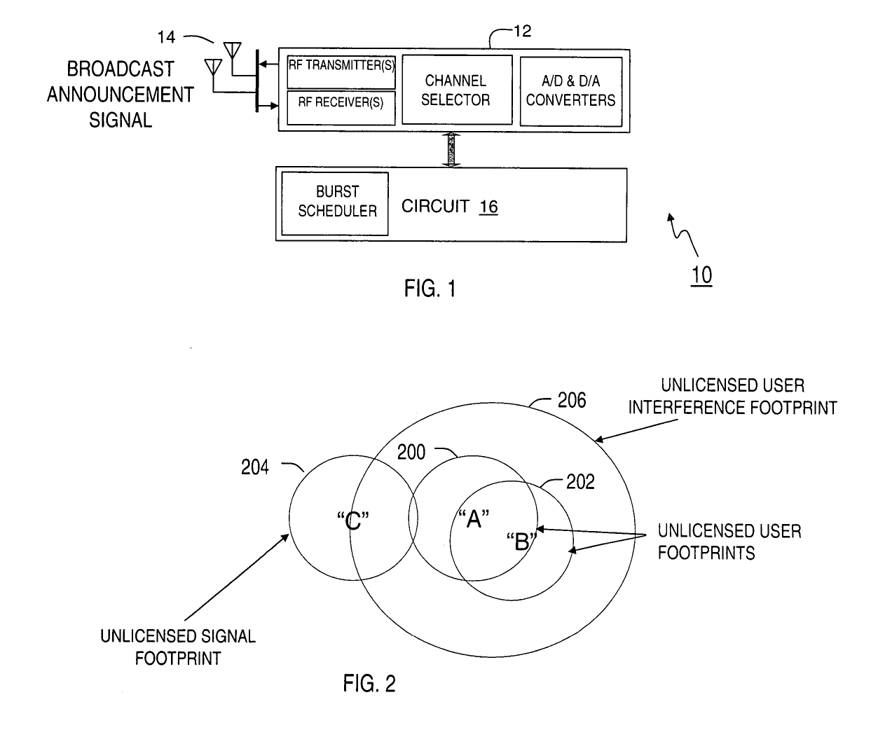

FIG. 1 illustrates features of the present invention that may be incorporated, for example, into a wireless communications device 10. In the wireless communications embodiment, a transceiver 12 both receives and transmits a modulated signal from one or multiple antennas 14. A received modulated signal may be frequency down-converted and converted to a baseband, digital signal for processing. In one embodiment, a circuit 16 may include baseband and applications processing functions and utilize one or more processor cores. Circuit 16 may system memory such as a Random Access Memory (RAM), a Read Only Memory (ROM) and a nonvolatile memory, although the type or variety of memories included in system memory is not a limitation of the present invention.

In accordance with the present invention, the radio in communications device 10 may be used to establish communication with other wireless devices that may operate in a variety of different networks. As such, different radio technologies may be built into the platform of communications device 10 that allow collocation and operability in selected networks that may employ cellular, Wireless Local Area Networks (WLANs), Wireless Personal Area Networking (WPAN), Worldwide Interoperability for Microwave Access (WiMax), Wireless Fidelity (Wi-Fi™), and Bluetooth™, among others. The type of network selected by communications device 10 does not limit the scope of the claimed invention.

These networks may use different modulation techniques such as Code Division Multiple Access (CDMA), WCDMA, Global System for Mobile Communications (GSM), Time-Division Multiplexing (TDM), Vestigial Side Band (VSB), Amplitude Modulation (AM), Phase Shift Keying (PSK) and Orthogonal Frequency Division Multiplexing (OFDM) to enable data communications and data exchanges at different frequencies for a variety of applications. The type of modulation selected by communications device 10 does not limit the scope of the claimed invention.

The radio in communications device 10 allows communication in an RF/location space with other devices and may include network connections to send and receive files or other information such as voice or video and high definition streaming video. As such, in some embodiments wireless communications device 10 may address communications using the 300 MHz of spectrum in the 5 GHz band set aside by the Federal Communications Commission (FCC). This spectrum permits use of the unlicensed Industrial, Scientific and Medical (ISM) and Unlicensed National Information Infrastructure (U-NII) bands for Wireless Local Area Networks (WLANs), business-to-business and last-mile (short haul) point-to-point and point-to-multipoint applications. The U-NII and ISM spectrum for unlicensed wideband operation may benefit a vast number of users, including educational, medical, business, and industrial users.

These unlicensed bands mean that the FCC does not require a license for systems operating in these bands, a factor that speeds service deployment and opens the market to providers. The unlicensed spectrum includes the U-NII band #1 at 5.00-5.25 GHz that is allocated primarily to the aeronautical radio navigation, aeronautical mobile-satellite, fixed-satellite, and inter-satellite services for both Government and non-Government operations. The U-NII band #2 at 5.25 to 5.35 GHz is designated for wireless LAN and other short-range use. The U-NII band #3 at 5.650-5.925 GHz is designated for ISM applications and for wide-area networking that reaches a greater distance with higher power.

In accordance with the present invention and by way of example, communications device 10 may be any wireless device capable of different radio technologies built into the platform that allow collocation and operability with other Wi-Fi™ and WiMAX enabled devices in the U-NII bands. Since the U-NII bands are open to any user, communications device 10 shares the spectrum and coexists with other types of wireless equipment. Shared spectrum opens the possibility of interference, but this obstacle may be overcome by incorporating algorithms and executing software designed with features for handling interference in accordance with the present invention.

FIG. 2 illustrates users “A” and “B” having respective signal footprints 200 and 202 that may coexist with a user “C” that has a signal footprint 204. By way of example, users “A”, “B” and “C” may be 802.11 (Wi-Fi™) devices and 802.16 (WiMAX) compatible devices that are collocated in heterogeneous unlicensed networks. Users “A” and “B” operating in the U-NII bands present a collective interference footprint 206 consisting of both intentional and spurious emissions that is larger than the useable communication footprint. In order to mitigate channel interference for these devices, one feature of the present invention is that user “C”, operating in this example as an 802.11 device, schedules transmission of a series of packets of sufficiently short duration that is receivable by non-802.11 devices.

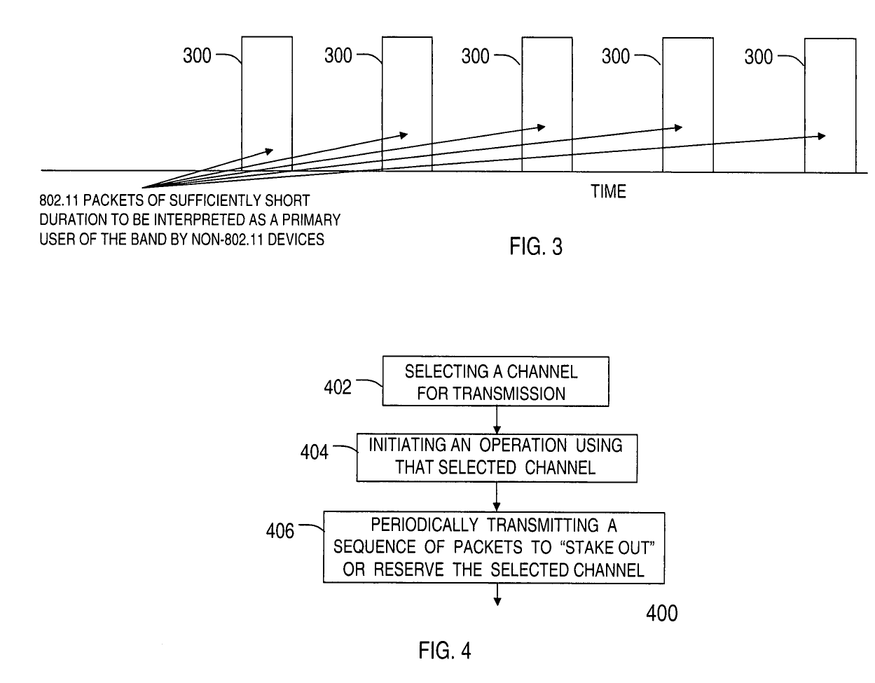

FIG. 3 illustrates the series of packets 300 that may be transmitted on a scheduled basis by user “C”. User “C” may operate with a first wireless protocol to select a channel and provide a sequence of transmissions recognizable by other devices employing that first wireless protocol. The sequence of transmissions, or burst of signals, illustrated by the series of packets 300 show signals of substantially similar duration with substantially similar intervals between the signals. In this embodiment users “A” and/or “B” may operate with a second wireless protocol, and therefore, these devices are unable to decode transmissions conforming to the first wireless protocol. In this case, upon receiving the series of packets 300 users “A” and/or “B” interpret the transmission sequence as being received from a primary user of the frequency band and cease transmissions on that channel. A primary user has granted rights that authorize access and priority to the channel that supersede the rights of non-primary users.

Note that the particular signaling format of five packets is for illustrative purposes and other information may be provided and a different number of packets provided to validate user “C” as a primary user. Users “A” and/or “B” respond to the received series of packets 300 by reserving the channel used by user “C”. By refraining from using the selected channel, users “A” and/or “B” grant another device (user “C”) that operates with a different protocol rights to that selected channel. Thus, in accordance with the present invention, a device using a first protocol can select a channel for its own transmissions by transmitting a series of packets to reserve that selected channel from being used by other collocated devices operating with a different protocol.

Note that in this example an 802.11 device (user “C”) may reserve privileges that include access to the selected channel. Further note, any non-802.11 devices (users “A” and “B”) that receive the series of packets 300 from the 802.11 device may be forced to switch to an alternate channel and preserve the selected channel for the 802.11 device. Thus, the algorithms and methods presented with the present invention may facilitate the coexistence of heterogeneous unlicensed devices that operate in the same frequency band. It should also be understood that a primary user or a licensed user may force the unlicensed users to switch to alternative channels so as not to interfere. Even though the example provided here describes the 802.11 device as providing the series of packets 300 to reserve a channel, this is not limiting to the claimed invention and a non-802.11 device may also provide the series of packets 300 to reserve a channel.

FIG. 4 shows a flowchart in accordance with various embodiments of the present invention. In some embodiments, method 400 may be used to trigger a device to select a channel in a frequency spectrum and provide dynamic frequency selection information. In some embodiments, method 400, or portions thereof, is performed by a central controller, a processor, or an electronic system, embodiments of which are shown in the various figures. Method 400 is not limited by the particular type of apparatus, software element, or system performing the method. The various actions in method 400 may be performed in the order presented, or may be performed in a different order. Further, in some embodiments, some actions listed in FIG. 4 are omitted from method 400.

Method 400 is shown beginning at block 402 in which a device such as, for example, an 802.11 device selects a channel in a frequency spectrum for transmission. A monitor block (not shown) cognitively monitors or scans the channels in order to determine occupied/vacant channels, set the transmit power for a given channel, etc. In block 404, the 802.11 device may initiate operation using the selected channel. In block 406, the 802.11 device may provide a periodic series of packets (series of packets 300, FIG. 3) that are recognizable to other devices using the protocol as being valid packet transmissions for that protocol. Each packet in the series may have the same or similar duration and the same or similar time interval to separate the packets. As a result of these transmissions, any non-802.11 device which does not recognize the packets as valid data packet transmissions will conclude that a primary user of the band is operating on that channel and avoid that channel.

Using the algorithms and methods described herein, the congested spectrum in the U-NII bands may accommodate both 802.11 device and 802.16 devices. The coexistence mechanism protects the 802.11 devices from being disadvantaged in the U-NII bands when significantly occupied by 802.16 devices.

By now it should be apparent that the present invention may allow wireless devices such as 802.11 (Wi-Fi™) devices and 802.16 (WiMAX) devices to coexist in heterogeneous unlicensed networks. These Wi-Fi™ and WiMAX devices may operate in the same frequency band, for example, the U-NII bands in the 5 GHz frequency range and realize the full potential of today's information technologies and broadband digital communications. The described spectrum etiquette ensures that the spectrum is used efficiently and Wi-Fi™ and WiMAX devices have access to the spectrum. The Wi-Fi™ and WiMAX devices may coexist to provide the new communications alternatives that are flexible, inexpensive and needed to assure delivery of information and services.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A circuit, comprising:
a transceiver device to transmit over a channel a sequence of transmissions that is recognizable by devices employing a first wireless protocol but interpreted by other devices unable to decode transmissions conforming to the first wireless protocol as being a primary user of a frequency band and cease transmissions on the channel.

2. The circuit of claim 1 wherein the sequence of transmissions includes transmitting multiple signals substantially equally spaced with similar duration.

3. The circuit of claim 1 wherein the other devices unable to decode transmissions conforming to the first wireless protocol are operating a second wireless protocol.

4. The circuit of claim 1 wherein transmitting the sequence of transmissions is periodic.

5. The circuit of claim 1 wherein the sequence of transmissions is a burst recognizable as valid packet data by the devices employing the first wireless protocol.

6. The circuit of claim 5 wherein transmitting over a channel a sequence of transmissions includes transmitting packets in Unlicensed National Information Infrastructure (U-NII) bands.

7. A system comprising:
a transceiver having a channel selector to select a channel; and
a transmitter in the transceiver using a first protocol to transmit a series of packets over the channel that are substantially equally spaced and of substantially equal duration, wherein the packets are recognizable by devices employing the first protocol but interpreted by other devices unable to decode transmissions conforming to the first protocol as being a primary user of a frequency band and cease transmissions on the channel.

8. The system of claim 7 wherein the channel selected by the channel selector is reserved for use by the transceiver.

9. The system of claim 7 wherein the system further includes a scheduler to periodically schedule the series of packets.

10. The system of claim 7 wherein the series of packets are transmitted over a channel in Unlicensed National Information Infrastructure (U-NII) bands.

11. The system of claim 7 wherein the first protocol operates in a Wireless Fidelity (Wi-Fi™) device and the other devices unable to decode transmissions conforming to the first protocol operate a second protocol in a Worldwide Interoperability for Microwave Access (WiMax) device.

12. A wireless device comprising:
a processor having a scheduler, a channel selector and a radio to transmit at least one packet over a channel selected by the channel selector at a time scheduled by the scheduler to communicate with collocated devices having a same protocol but alert devices having a different protocol to cease transmissions on the channel.

13. The wireless device of claim 12 wherein devices having a different protocol interpret the at least one packet as being transmitted by a primary user of a frequency band.

14. The wireless device of claim 12 wherein the channel selector selects a channel to reserve for further transmissions by the radio.

15. The wireless device of claim 12 wherein the scheduler transmits the at least one packet at selected times to repeatedly alert the devices to avoid transmitting on the channel.

16. A method, comprising:
selecting a channel in a radio for transmission;
initiating an operation using the selected channel; and
periodically transmitting a sequence of packets over the selected channel to reserve the selected channel from being used by devices that receive the sequence of packets and are unable to decode transmissions conforming to a protocol used by the radio.

17. The method of claim 16 wherein transmitting the sequence of packets further includes designating the radio as a primary user of a frequency band.

18. The method of claim 16 wherein transmitting the sequence of packets further includes recognizing the sequence of packets by devices employing a same protocol as the radio.

19. The method of claim 16 wherein transmitting the sequence of packets further includes interpreting the sequence of packets by the devices unable to decode transmissions conforming to the protocol as being a primary user.

20. The method of claim 16 wherein the radio and the devices coexist in heterogeneous unlicensed networks.
